(19) United States
(12) Patent Application Publication
(10) Pub. No.: US 2021/0118372 A1
(43) Pub. Date: Apr. 22, 2021

(54) Display panel, method for driving the same, and display apparatus

(71) Applicant: BOE Technology Group Co., Ltd, Beijing (CN)

(72) Inventors: Hui Zhao, Beijing (CN); Jing Yu, Beijing (CN); Wenxiu Zhu, Beijing (CN)

(21) Appl. No.: 16/754,165

(22) PCT Filed: Aug. 29, 2019
(86) PCT No.: PCT/CN2019/103303

§ 371 Date: Apr. 7, 2020

(30) Foreign Application Priority Data
Nov. 9, 2018 (CN) 201811329363.4

(51) Int. Cl. G09G 3/3266; G09G 3/3225; G09G 3/3216; G09G 3/3275

(52) U.S. Cl. CPC G09G 3/3266; G09G 3/3225; G09G 3/3216; G09G 2300/0408; G09G 2310/08; G09G 2310/0221; G09G 3/3275

(57) ABSTRACT

The present disclosure provides a display panel, a method for driving the same, and a display apparatus. The display panel includes: a first display region and a first driving circuit, wherein the first driving circuit is configured to drive the first display region to display a first target image; and a second display region and a second driving circuit, wherein the second driving circuit is configured to drive the second display region to display a second target image.

### CROSS-REFERENCE TO RELATED APPLICATION(S)

This application is a Section 371 National Stage Application of International Application No. PCT/CN2019/103303, filed on Aug. 29, 2019, which has not yet published, and claims priority to the Chinese Patent Application No. CN201811329363.4, filed on Nov. 9, 2018, which is incorporated herein by reference in their entireties.

### TECHNICAL FIELD

The present disclosure relates to the field of display technology, and more particularly, to a display panel, a method for driving the same, and a display apparatus.

### BACKGROUND

Full-screen mobile phones have attracted more and more attention from consumers. Since the full-screen mobile phones have no bezels or small bezels, an effective display region of each of the full-screen phones covers the entire front panel. As a result, sensors which are originally disposed at a bezel need to occupy a space behind a screen in the effective display region now. These sensors may also be referred to as behind-screen sensors. However, existing Active Matrix Organic Light-Emitting Diode (AMOLED) display panels do not have high transmittance, and may not meet the requirements of the behind-screen sensors, which brings limitations to the realization of AMOLED full-screen mobile phones.

### SUMMARY

According to an aspect of the present disclosure, there is proposed a display panel, comprising:

a first display region and a first driving circuit, wherein the first driving circuit is configured to drive the first display region to display a first target image; and

a second display region and a second driving circuit, wherein the second driving circuit is configured to drive the second display region to display a second target image,

wherein the first display region is an Active Matrix Organic Light Emitting Diode (AMOLED) display region, and the second display region is a Passive Matrix Organic Light Emitting Diode (PMOLED) display region.

In some embodiments, the first driving circuit comprises a first gate driving circuit and a first source driving circuit, wherein the first gate driving circuit is disposed on a first side of an effective display region of the display panel, and the first source driving circuit is disposed on a second side of the effective display region of the display panel, wherein the second side is adjacent to the first side.

In some embodiments, the second display region is located at a corner formed by a third side and a fourth side adjacent to each other of the effective display region of the display panel, wherein the third side is opposite to the first side, and the fourth side is opposite to the second side.

In some embodiments, the first driving circuit comprises a first gate driving circuit and a first source driving circuit, wherein the first gate driving circuit is disposed on a first side and a third side of an effective display region of the display panel, and the first source driving circuit is disposed on a second side of the effective display region of the display panel, wherein the third side is opposite to the first side, the second side is adjacent to the first side.

In some embodiments, the second display region is located at an edge of a fourth side of the effective display region of the display panel, wherein the fourth side is opposite to the second side.

In some embodiments, a first portion of the first gate driving circuit on the first side is connected to gate lines corresponding to respective rows of pixels of the display panel, a second portion of the first gate driving circuit on the third side is also connected to the gate lines corresponding to the respective rows of pixels of the display panel, and the first portion and the second portion provide gate driving signals to the respective gate lines connected thereto.

In some embodiments, a first portion of the first gate driving circuit on the first side is connected to gate lines corresponding to odd-numbered rows of pixels of the display panel, a second portion of the first gate driving circuit on the third side is connected to gate lines corresponding to even-numbered rows of pixels of the display panel, and the first portion and the second portion provide gate driving signals to the respective gate lines connected thereto.

In some embodiments, the first display region and the second display region together constitute an effective display region of the display panel.

In some embodiments, the first target image and the second target image are displayed synchronously and constitute a target image.

According to another aspect of the present disclosure, there is proposed a display apparatus, comprising the display panel according to any of the embodiments described above.

In some embodiments, the display apparatus further comprises: a processor. The processor is electrically connected to the first driving circuit and the second driving circuit, and is configured to provide, to the first driving circuit and the second driving circuit, data information of the first target image and the second target image and control signals for causing the first display region and the second display region to display the first target image and the second target image synchronously.

In some embodiments, the display apparatus further comprises: a behind-screen sensor disposed between a display surface of the display panel and a substrate, wherein orthographic projection of the behind-screen sensor on the substrate is located within orthographic projection of the second display region on the substrate, such that the behind-screen sensor senses a signal on the second display region which is transmitted through the display surface.

According to yet another aspect of the present disclosure, there is proposed a method for driving the display panel according to any of the embodiments described above. The method comprises:

providing a first image signal to the first driving circuit, wherein the first image signal is at least used to display the first target image;

providing a second image signal to the second driving circuit, wherein the second image signal is at least used to display the second target image; and

providing timing signals to the first driving circuit and the second driving circuit, so that the first driving circuit and the second driving circuit drive the first display region and the second display region respectively to display the first target image and the second target image synchronously.

### BRIEF DESCRIPTION OF THE ACCOMPANYING DRAWINGS

The above and other purposes, features, and advantages of the present disclosure will be more apparent from the following description of the embodiments of the present disclosure with reference to the accompanying drawings, in which:

FIG. 1A illustrates a cross-sectional view of an exemplary AMOLED display panel in a thickness direction.

FIG. 1B illustrates a structural schematic diagram of an array substrate in an exemplary AMOLED display panel.

FIG. 2 illustrates a schematic structural diagram of an exemplary PMOLED display panel.

FIG. 3 illustrates a schematic diagram of a display panel according to an embodiment of the present disclosure.

FIG. 4 illustrates a schematic diagram of a display panel according to another embodiment of the present disclosure.

FIG. 5 illustrates a schematic diagram of a display apparatus according to an embodiment of the present disclosure.

FIG. 6 illustrates a flowchart of a method for driving a display panel according to an embodiment of the present disclosure.

### DETAILED DESCRIPTION

Hereinafter, exemplary embodiments of the present disclosure will be described in detail with reference to the accompanying drawings. Throughout the accompanying drawings, the same elements are denoted by the same or similar reference numerals. In the following description, some specific embodiments are for illustrative purposes only and are not to be construed as limiting the present disclosure, but merely examples of the embodiments of the present disclosure. The conventional structure or construction will be omitted when it may cause confusion with the understanding of the present disclosure. It should be illustrated that shapes and sizes of various components in the figures do not reflect true sizes and proportions, but only illustrate contents of the embodiments of the present disclosure.

Throughout the specification, the reference to “one embodiment,” “an embodiment,” “one example” or “an example” means that the specific features, structures or properties described in conjunction with the embodiment or example are included in at least one embodiment of the present disclosure. Therefore, the phrases “in one embodiment,” “in an embodiment,” “in one example” or “in an example” occurred in various positions throughout the specification may not necessarily refer to the same embodiment or example. Furthermore, specific features, structures or properties may be combined into one or more embodiments or examples in any appropriate combination and/or sub-combination.

It should also be illustrated that, it may be understood by those skilled in the art that the terms “A and B are electrically connected” and “A is electrically connected to B” herein may mean that A is electrically connected to B directly, or A is electrically connected to B through one or more other components.

In addition, it should also be illustrated that the “target image” hereinafter refers to a complete image to be displayed in the entire effective display region.

The present disclosure will be described in detail below with reference to the accompanying drawings.

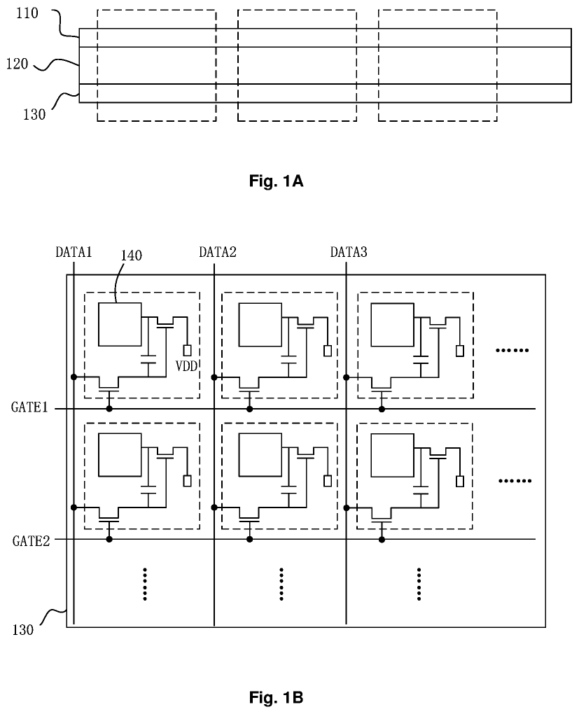

FIG. 1A illustrates a cross-sectional view of an exemplary AMOLED display panel in a thickness direction (or a normal direction of the display panel). FIG. 1B illustrates a structural schematic diagram of an array substrate in an exemplary AMOLED display panel.

As may be seen from FIG. 1A, the AMOLED display panel comprises a cathode layer 110, an organic layer 120, and an array substrate 130. In addition, as may be seen according to FIG. 1B, the array substrate 130 comprises a plurality of pixels (each dotted block schematically represents one pixel) arranged in a matrix form, and each pixel comprises an anode electrode 140. The AMOLED display panel causes the organic layer 120 in the respective pixels to emit light stably by forming stable driving current between the anode electrodes 140 in the respective pixels and the cathode layer 110, so that the display panel presents a desired image.

Specifically, the AMOLED display panel provides gate driving signals to gate lines (for example, GATE1 and GATE2) through a gate driving circuit (for example, a GOA driving circuit), and provides source driving signals to data lines (for example, DATA1 to DATA3) through a source driving circuit, so as to achieve display driving for the AMOLED display panel.

A pixel circuit of each pixel is exemplified in FIG. 1B as having a 2T1C structure (having two transistors and one storage capacitor). In the AMOLED display panel, due to the presence of the storage capacitors, after each pixel is scanned and driven to emit light, the pixel may continuously emit light during one frame, and thereby does not require high instantaneous brightness, has low power consumption and a long lifetime, and thus may be used to implement large-sized display panels.

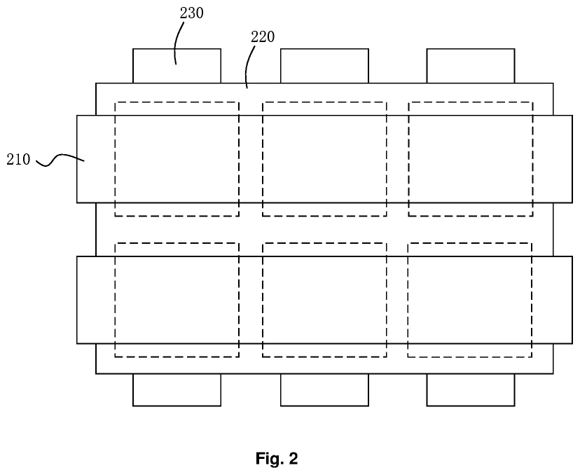

FIG. 2 illustrates a schematic structural diagram of an exemplary PMOLED display panel.

As may be seen from FIG. 2, the PMOLED display panel comprises cathode electrodes 210, an organic layer 220, and anode electrodes 230. Here, the plurality of parallel stripe cathode electrodes 210 (i.e., horizontal row electrodes) and the plurality of parallel stripe anode electrodes 230 (i.e., vertical column electrodes) are arranged perpendicular to each other on upper and lower sides of the organic layer 220 respectively. Overlapping regions of the cathode electrodes 210 and the respective anode electrodes 230 in a normal direction of the substrate form a pixel matrix (as shown by respective dotted blocks in FIG. 2).

Specifically, in the PMOLED display panel, respective driving signals are applied to the cathode electrodes 210 and the anode electrodes 230 through a row driving circuit and a column driving circuit, respectively, and instantaneous current is formed on pixels in the overlapping regions of the cathode electrodes 210 and the anode electrodes 230, to cause the pixels to emit strong instantaneous brightness. The respective cathode electrodes 210 and the respective anode electrodes 230 are sequentially scanned to realize complete image display of human eyes by using a residual image generated in the human eyes through instantaneous light emission.

Compared with the AMOLED display panel, the PMOLED display panel requires higher instantaneous brightness and higher power consumption. However, there is no need to dispose an array substrate in the PMOLED, which has a simpler structure.

When a large-sized display panel is manufactured, the AMOLED panel is often used to achieve the large-sized display panel. However, compared to the PMOLED, the AMOLED has lower transmittance due to the presence of the array substrate, which adversely affects the realization of the behind-screen sensors therein.

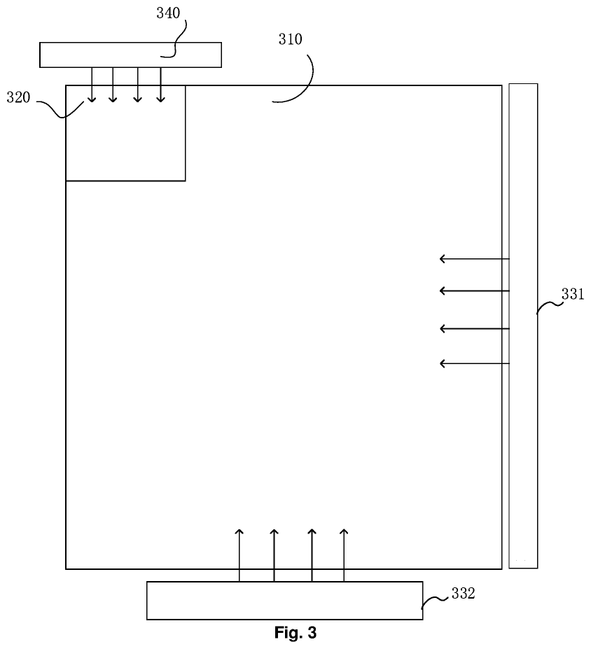

FIG. 3 illustrates a schematic diagram of a display panel according to an embodiment of the present disclosure.

As shown in FIG. 3, the display panel comprises a first display region 310 and a second display region 320. It should be illustrated that in FIG. 3, for convenience of description, the entire effective display region is shown as comprising only the first display region 310 and the second display region 320. However, in other embodiments, the effective display region may further comprise other regions.

In some embodiments, the first display region is an AMOLED region and the second display region is a PMOLED region. It should be understood that, in other embodiments, the first display region and the second display region may also be implemented as regions which are driven for display in other ways. For example, the first display region is a PMOLED region and the second display region is an AMOLED region, which is not limited in the present disclosure. For convenience of description, the present embodiment is described by taking the first display region being an AMOLED region and the second display region being a PMOLED region as an example.

FIG. 3 further illustrates a first driving circuit, which comprises a first gate driving circuit 331 for providing gate driving signals to gate lines in the first display region 310 and a first source driving circuit 332 for providing source driving signals to data lines in the first display region 310.

The first gate driving circuit 331 is configured to drive the first display region 310 to display a first target image (a first portion of a target image). In some embodiments, the first gate driving circuit 331 may be a Gate On Array (GOA) circuit, which may be manufactured on an array substrate together with pixels.

In the embodiment shown in FIG. 3, a single-side gate driving method is adopted, the first gate driving circuit 331 is disposed only on a first side (for example, a right side shown in FIG. 3) of the effective display region of the display panel, and the first source driving circuit 332 is disposed on a second side (for example, a lower side shown in FIG. 3) of the effective display region of the display panel. In this case, as shown in FIG. 3, the second display region 320 may be located at a corner formed by a third side and a fourth side adjacent to each other in the effective display region of the display panel, wherein the third side is opposite to the first side, and the fourth side is opposite to the second side.

The reason why the second display region 320 is disposed in this way is to ensure that each pixel in the first display region 310 may receive the gate driving signal and the source driving signal, and it is not necessary to implement special arrangements and settings for a wiring on the panel. Otherwise, if there is a gap between the second display region 320 and the third side or the fourth side, pixels in a portion of the first display region 310 in the gap may not receive the gate driving signals through the gate lines or may not receive the source driving signals through the data lines due to being blocked by the second display region 320, and thereby normal display may not be achieved.

FIG. 3 further illustrates a second driving circuit 340, which operates independently of an operation of the first driving circuit, and is configured to drive the second display region 320 to display a second target image (a second portion of the target image). It should be understood that “operates independently” herein means that one driving circuit may operate without being controlled or influenced by another driving circuit, and does not mean that there is no correlation between inputs and outputs of the two driving circuits in terms of timing, frequency, or amplitude.

In some embodiments, the first target image and the second target image are stitched into the target image.

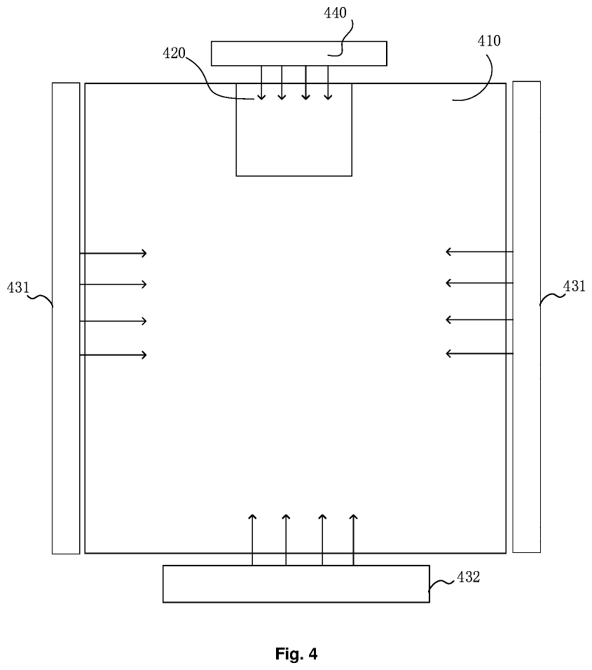

FIG. 4 illustrates a schematic diagram of a display panel according to another embodiment of the present disclosure.

As shown in FIG. 4, the display panel comprises a first display region 410 and a second display region 420. It should be illustrated that in FIG. 4, for convenience of description, the entire effective display region is shown as comprising only the first display region 410 and the second display region 420. However, in other embodiments, the effective display region may further comprise other regions.

In some embodiments, the first display region is an AMOLED region and the second display region is a PMOLED region. It should be understood that, in other embodiments, the first display region and the second display region may also be implemented as regions which are driven for display in other ways. For example, the first display region is a PMOLED region and the second display region is an AMOLED region, which is not limited in the present disclosure. For convenience of description, the present embodiment is described by taking the first display region being an AMOLED region and the second display region being a PMOLED region as an example.

FIG. 4 further illustrates a first driving circuit, which comprises a first gate driving circuit 431 for providing gate driving signals to gate lines in the first display region 410 and a first source driving circuit 432 for providing source driving signals to data lines in the first display region 410.

The first gate driving circuit 431 is configured to drive the first display region 410 to display a first target image. In some embodiments, the first gate driving circuit 431 may be a GOA circuit, which may be manufactured on an array substrate together with pixels.

In the embodiment shown in FIG. 4, a dual-side gate driving method is adopted, the first gate driving circuit 431 is disposed on a first side (for example, a right side shown in FIG. 4) and a third side (for example, a left side shown in FIG. 4) opposite to the first side of the effective display region of the display panel, and the first source driving circuit 432 is disposed on a second side (for example, a lower side shown in FIG. 4) of the effective display region of the display panel. In this case, as shown in FIG. 4, the second display region 420 may be located at an edge of a fourth side opposite to the second side of the effective display region of the display panel.

The reason why the second display region 420 is disposed in this way is to ensure that each pixel in the first display region 410 may receive the gate driving signal and the source driving signal, and it is not necessary to implement special arrangements and settings for a wiring on the panel. Otherwise, if there is a gap between the second display region 420 and the fourth side, pixels in a portion of the first display region 410 in the gap may not receive the source driving signals through the data lines due to being blocked by the second display region 420, and thereby normal display may not be achieved.

In the embodiment of FIG. 4, the dual-side gate driving is adopted, so that the second display region is not limited to be disposed at the corner in the embodiment of FIG. 3, and thereby a behind-screen sensor may be more flexibly disposed in the manufactured display panel.

FIG. 4 further illustrates a second driving circuit 440, which operates independently of an operation of the first driving circuit, and is configured to drive the second display region 420 to display a second target image.

In some embodiments, the first target image and the second target image are stitched into the target image.

In some embodiments, a first portion of the first gate driving circuit 431 on the first side is connected to gate lines corresponding to respective rows of pixels of the display panel, and a second portion of the first gate driving circuit 431 on the third side is also connected to the gate lines corresponding to the respective rows of pixels of the display panel. These two portions of the first gate driving circuit 431 provide gate driving signals to the respective gate lines connected thereto respectively. In the present disclosure, gate lines where the second display region 420 is arranged are broken. It may be considered that a broken gate line is still a gate line comprising two separated portions, of which one portion is located between the second display region 420 and the first side, and the other portion is located between the second display region 420 and the third side. Alternatively, it may also be considered that the broken gate line form two gate lines, which are connected to the same row of pixels and are used to drive parts of the row of pixels respectively. It should be understood that no matter how the broken gate line is defined, it may not affect the implementation of the embodiments of the present disclosure. In the above embodiment, the two separated portions of the broken gate line (or the two gate lines formed by the broken gate line) are driven by the first portion and the second portion of the first gate driving circuit respectively without affecting the display effect of the first display region.

In some other embodiments, the first portion of the first gate driving circuit 431 on the first side is connected to gate lines corresponding to odd-numbered rows of pixels of the display panel, and the second portion of the first gate driving circuit 431 on the third side is connected to gate lines corresponding to even-numbered rows of pixels of the display panel. The two portions of the first gate driving circuit 431 provide gate driving signals to the respective gate lines connected thereto respectively. In this embodiment, only one of two separated portions of the broken gate line (or two separated gate lines formed by the broken gate line) is driven by the first portion or the second portion of the first gate driving circuit. In a case where the second display region 420 has a small area, a resolution of a region of rows of pixels corresponding to the second display region 420 may be appropriately sacrificed (this region may be used to display specific content which is not sensitive to the resolution), so as to achieve a simpler structure of the driving circuit.

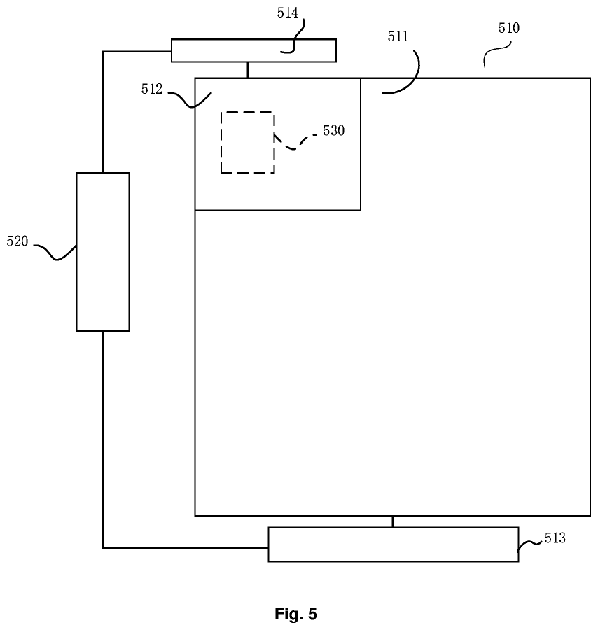

FIG. 5 illustrates a schematic diagram of a display apparatus 500 according to an embodiment of the present disclosure.

As shown in FIG. 5, the display apparatus 500 comprises a display panel 510, a processor 520, and a behind-screen sensor 530.

The display panel 510 may be the display panel (for example, the display panel shown in FIG. 3 or FIG. 4) according to various embodiments of the present disclosure, and comprises a first display region 511 and a second display region 512. In some embodiments, the first display region 511 shown is an AMOLED region, and the second display region 512 is a PMOLED region.

Similarly, the display panel 510 further comprises a first driving circuit 513 and a second driving circuit 514. The first driving circuit 513 is configured to drive the first display region 511 to display a first target image, and the second driving circuit 514 is configured to drive the second display region 512 to display a second target image. It should be understood that a positional relationship and an electrical connection relationship between the first driving circuit 513 and the second driving circuit 514 in FIG. 5 are only schematically shown, and are not used to limit a specific electrical connection relationship and a specific positional relationship.

The processor 520 may be any form of processing unit or module, for example, a central processing unit of a computer, a processing chip of a mobile phone, etc. The processor 520 is electrically connected to the first driving circuit 513 and the second driving circuit 514 and is configured to provide signals to the first driving circuit 513 and the second driving circuit 514, so that the first driving circuit 513 and the second driving circuit 514 drive the first display region 511 and the second display region 512 to display respective target images synchronously, and content displayed in the two regions may present a predetermined display effect. Specifically, the processor 520 may provide, to the first driving circuit 513 and the second driving circuit 514, data information of the first target image and the second target image and control signals for causing the first display region 511 and the second display region 512 to display the first target image and the second target image (the first target image and the second target image constitute one target image) synchronously. In some embodiments, for the first driving circuit 513 (which is exemplified as an AMOLED driving circuit), the data information may indicate a level of a signal to be applied to a data line of a pixel circuit of each pixel, and the control signal may comprise, but not limited to, an input signal of a gate driving circuit. As another example, for the second driving circuit 514 (which is exemplified as a PMOLED driving circuit), the data information may indicate a voltage to be applied to a cathode electrode, and the control signal may be used to control a timing of scanning anode electrodes and cathode electrodes.

The behind-screen sensor 530 may be any sensor suitable for being installed under the display panel and sensing a signal transmitted through the display panel, and is, for example, an infrared sensor, an optical sensor, a proximity sensor, etc.

In the embodiment shown in FIG. 5, the behind-screen sensor 530 is disposed at a position corresponding to the second display region 512 between a display surface of the display panel 510 and the substrate, so as to be able to sense the signal on the second display region 512 which is transmitted through the display surface.

It should be understood that although the processor 520 and the behind-screen sensor 530 are shown in the embodiment of FIG. 5, in other embodiments of the present disclosure, at least one of the processor 520 and the behind-screen sensor 530 may be omitted, or other elements may be added, which is not limited in the present disclosure.

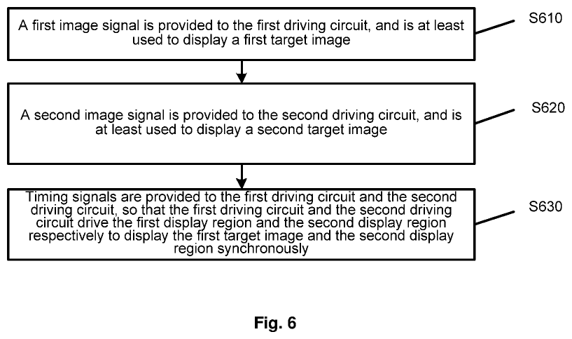

FIG. 6 illustrates a flowchart of a method 600 for driving a display panel according to an embodiment of the present disclosure. The method 600 may be used to drive the display panel according to any embodiment of the present disclosure (for example, the embodiment of FIG. 3 or FIG. 4). Therefore, the explanations and descriptions given above in conjunction with FIG. 3 and FIG. 4 are also applicable here.

The method 600 comprises steps S610 to S630.

In step S610, a first image signal is provided to the first driving circuit, and is at least used to display a first target image.

In some embodiments, the first image signal is only used to display the first target image.

In some other embodiments, the first image signal is used to display the entire target image.

In step S620, a second image signal is provided to the second driving circuit, and is at least used to display a second target image.

In some embodiments, the second image signal is only used to display the second target image.

In other embodiments, the second image signal is used to display the entire target image.

In step S630, timing signals are provided to the first driving circuit and the second driving circuit, so that the first driving circuit and the second driving circuit drive the first display region and the second display region respectively to display the first target image and the second display region synchronously.

In some embodiments, the method 600 may be implemented by a processor for controlling the first driving circuit and the second driving circuit, for example, the processor 520 in the display apparatus as shown in FIG. 5.

The detailed description above has set forth numerous embodiments by using schematic diagrams, flowcharts and/or examples. In a case where such schematic diagrams, flowcharts, and/or examples comprise one or more functions and/or operations, it should be understood by those skilled in the art that each of the functions and/or operations in such schematic diagrams, flowcharts, or examples may be implemented individually and/or collectively by various structures, hardware, software, firmware or substantially any combination thereof.

Although the present disclosure has been described with reference to a few exemplary embodiments, it is understood that the terms used are illustrative and exemplary and not restrictive. The present disclosure may be embodied in a variety of forms without departing from the spirit or substance of the present disclosure. Therefore, it is to be understood that the embodiments described above are not limited to any detail described above, but are construed broadly within the spirit and scope defined by the appended claims. Accordingly, all changes and modifications which fall within the scope of the claims or the equivalents thereof are intended to be covered by the appended claims.

1. A display panel, comprising:
a first display region and a first driving circuit, wherein the first driving circuit is configured to drive the first display region to display a first target image; and
a second display region and a second driving circuit, wherein the second driving circuit is configured to drive the second display region to display a second target image,
wherein the first display region is an Active Matrix Organic Light Emitting Diode (AMOLED) display region, and the second display region is a Passive Matrix Organic Light Emitting Diode (PMOLED) display region.

2. The display panel according to claim 1, wherein the first driving circuit comprises a first gate driving circuit and a first source driving circuit, wherein the first gate driving circuit is disposed on a first side of an effective display region of the display panel, and the first source driving circuit is disposed on a second side of the effective display region of the display panel, wherein the second side is adjacent to the first side.

3. The display panel according to claim 2, wherein the second display region is located at a corner formed by a third side and a fourth side adjacent to each other of the effective display region of the display panel, wherein the third side is opposite to the first side, and the fourth side is opposite to the second side.

4. The display panel according to claim 1, wherein the first driving circuit comprises a first gate driving circuit and a first source driving circuit, wherein the first gate driving circuit is disposed on a first side and a third side of an effective display region of the display panel, and the first source driving circuit is disposed on a second side of the effective display region of the display panel, wherein the third side is opposite to the first side, the second side is adjacent to the first side.

5. The display panel according to claim 4, wherein the second display region is located at an edge of a fourth side of the effective display region of the display panel, wherein the fourth side is opposite to the second side.

6. The display panel according to claim 4, wherein a first portion of the first gate driving circuit on the first side is connected to gate lines corresponding to respective rows of pixels of the display panel, a second portion of the first gate driving circuit on the third side is also connected to the gate lines corresponding to the respective rows of pixels of the display panel, and the first portion and the second portion provide gate driving signals to the respective gate lines connected thereto.

7. The display panel according to claim 4, wherein a first portion of the first gate driving circuit on the first side is connected to gate lines corresponding to odd-numbered rows of pixels of the display panel, a second portion of the first gate driving circuit on the third side is connected to gate lines corresponding to even-numbered rows of pixels of the display panel, and the first portion and the second portion provide gate driving signals to the respective gate lines connected thereto.

8. The display panel according to claim 1, wherein the first display region and the second display region together constitute an effective display region of the display panel.

9. The display panel according to claim 1, wherein the first target image and the second target image are displayed synchronously and constitute a target image.

10. A display apparatus, comprising the display panel according to claim 1.

11. The display apparatus according to claim 10, further comprising: a processor electrically connected to the first driving circuit and the second driving circuit, and configured to provide, to the first driving circuit and the second driving circuit, data information of the first target image and the second target image and control signals for causing the first display region and the second display region to display the first target image and the second target image synchronously.

12. The display apparatus according to claim 10, further comprising: a behind-screen sensor disposed between a display surface of the display panel and a substrate, wherein orthographic projection of the behind-screen sensor on the substrate is located within orthographic projection of the second display region on the substrate, such that the behind-screen sensor senses a signal at the second display region which is transmitted through the display surface.

13. A method for driving the display panel according to claim 1, comprising:
providing a first image signal to the first driving circuit, wherein the first image signal is at least used to display the first target image;
providing a second image signal to the second driving circuit, wherein the second image signal is at least used to display the second target image; and
providing timing signals to the first driving circuit and the second driving circuit, so that the first driving circuit and the second driving circuit drive the first display region and the second display region respectively to display the first target image and the second target image synchronously.
